(19) United States
(12) Patent Application Publication
(10) Pub. No.: US 2020/0356894 A1
(43) Pub. Date: Nov. 12, 2020

(54) VISIT PREDICTION

(71) Applicant: Foursquare Labs, Inc., New York, NY (US)

(72) Inventors: Max Sklar, New York, NY (US); Robert Stewart, Brooklyn, NY (US); Runxin Li, New York, NY (US); Adrian Bakula, New York, NY (US); Ely Spears, New York, NY (US)

(21) Appl. No.: 16/405,481

(22) Filed: May 7, 2019

(51) Int. Cl. G06N 20/00; G06F 16/29

(52) U.S. Cl. CPC G06N 20/00; G06F 16/29

(57) ABSTRACT

Examples of the present disclosure describe systems and methods for visit prediction using machine learning (ML) attribution techniques. In aspects, data relating to users and their venue visits is collected and merged with data relating to various directed information impressions. Features of the merged data are identified for one or more time intervals and assigned values and/or labels. The identified features and corresponding values/labels may be used to train an ML model to provide a visit probability for each user represented in the merged data. Based on the visit probabilities provided by the ML model, the percentage increase (or “lift”) in venue visit rates attributable to the directed information impressions can be accurately estimated

### BACKGROUND

Generally, marketing attribution refers to the identification of a set of actions or events that contribute to the effectiveness of directed information, and the assignment of values to each action or event. In many cases, the set of actions or events are based on a staggering amount of variables (such as demographics, location, date, exposure length, exposure medium, etc.) for various users associated with the directed information. Accurately quantifying the respective impacts of the various variables on user behavior is a complicated, and often, unachievable task.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for visit prediction using machine learning (ML) attribution techniques. In aspects, data relating to users and their venue visits is collected and merged with data relating to various directed content impressions. Features of the merged data are identified for one or more time intervals and assigned values and/or labels. The identified features and corresponding values/labels may be used to train an ML model to provide a visit probability for each user represented in the merged data. Based on the visit probabilities provided by the ML model, the percentage increase (or “lift”) in venue visit rates attributable to the directed content impressions can be accurately estimated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for visit prediction using ML techniques as described herein.

FIG. 2 illustrates an example input processing unit for visit prediction using ML techniques as described herein.

FIG. 3 illustrates an example method for training a visit prediction model as described herein.

FIG. 4 illustrates an example method for determining user visit lift as described herein.

FIG. 5 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Visit probability (e.g., the probability that a person will visit, or has visited, a location or venue) is often affected by several demographic and psychographic factors. One potentially significant factor may be a person's exposure to directed information related to a particular location or venue. The significance (or effectiveness) of such directed information is based on several variables. Accurately attributing the individual causal impacts of these variables on the decision to visit is often difficult, if not impossible. However, attributing the individual causal impacts of the variables is essential to determining an exposed person's expected visit rate (e.g., what the visit behavior of an exposed person would have been had the person not been exposed to the directed information). Thus, without an accurate expected visit rate, the actual significance/effectiveness of viewed directed information is generally not accurately quantifiable.

To address such issues, the present disclosure describes systems and methods for determining user visit lift using machine learning (ML) attribution techniques. Visit lift, as used herein, may refer to the increase in location visit rate attributed to one or more events or actions. As a particular example, visit lift may refer to the percentage increase in venue visit rate attributable to directed information. Directed information may be content (e.g., text, audio, and/or video content), metadata, instructions to perform an action, tactile feedback, or any other form of information capable of being transmitted and/or displayed by a device. In aspects, user identification data and/or user visit data for one or more locations may be collected. The collected data may be labeled and/or unlabeled. In examples, the user identification data and/or user visit data may be related to directed information. Information relating to impressions for the directed information may also be collected. In examples, the impression information may comprise, among other things, directed information identifiers and an indication of the number of times directed information (or a medium comprising the directed information) is fetched and/or loaded. The identification data and/or user visit data and impression information may be merged into one or more data sets. An open-ended number of features of the merged data may then be identified. Example features include, but are not limited to, user age, user gender, user language, household income, user or mobile device location, number of children in household, date, day of the week, recency of previous visits, distance to venue or visit location, application(s) generating the visit data, capabilities of the device generating the visit data, directed information identifier, directed information exposure date/time, etc. In examples, enabling an open-ended number of features to be used in the visit prediction analysis may enable the resulting ML model (described below) to be easily and dynamically modified when additional features are added to the analysis. Additionally, enabling an open-ended number of features to be used may provide for a more granular and accurate attribution analysis.

In aspects, the identified features of the merged data may be organized into groups corresponding to individual users and/or individual days. Feature values may be calculated for and/or assigned to the respective features in each group using one or more featurization techniques. The feature values may be a numerical representation of the feature, a value paired to the feature in the merged data, an indication of one or more condition states for the feature, an indication of how predictive the feature is of a visit, or the like. Alternately or additionally, each group may be assigned a value for each feature corresponding to that group. In examples, the featurization techniques may include the use of ML processing, normalization operations, binning operations, and/or vectorization operations. In some aspects, each group may be assigned a visit indication value. The visit indication value may indicate whether a user visited a location or a venue. The visit indication value may also indicate whether a user has been exposed to directed information and/or whether a visit occurred within a statistically relevant time period of the exposure.

In aspects, a first set of data comprising the identified features, feature values, and/or the visit indication value(s) may be provided to a model to train the model to determine whether, or a probability that, a user visited a location/venue on a particular date. A model, as used herein, may refer to a predictive or statistical model that may be used to determine a probability distribution over one or more character sequences, classes, objects, result sets or events, and/or to predict a response value from one or more predictors. A model may be based on, or incorporate, one or more rule sets, machine learning, a neural network, or the like. In some examples, a model may be trained primarily (or exclusively) using data for unexposed users (e.g., users not exposed to the directed information). In other examples, a model may be trained primarily (or exclusively) using data for exposed users (e.g., users exposed to the directed information). In still other examples, a model may be trained using data for both exposed and unexposed users. In any such examples, the trained models may be configured to accurately estimate/measure the typical or expected visit behavior of a user that has not been exposed to the directed information.

In aspects, after the model has been trained, users exposed to the directed information described above are identified. The user identification data, user visit data and impression information for the exposed users are collected. The collected data is merged described above and provided to the trained model. Based on the collected data, a time period for which the merged data is to be analyzed may be identified. The analysis time period may correspond to the eligible days for the users identified in the merged data. Eligible days, as used herein, may refer to the days on which the effect of the directed information are to be calculated. In examples, eligible days may be determined using the date on which a user was exposed to directed information (e.g., the directed information exposure date) and a period of time subsequent to the directed information exposure date. Collectively, the eligible days may define an attribution window. An attribution window, as used herein, may refer to a time period including directed information exposure date and a period of time subsequent to the directed information exposure date. As a specific example, an attribution window of five days may include the directed information exposure date and the four days immediately subsequent to the directed information exposure date.

In aspects, for each eligible day identified, the model may calculate and/or output a result set comprising a visit determination and/or visit probability for each exposed user. The visit determinations/probabilities of the users may be summed to calculate a value indicating the total expected visit rate of the users for a location or venue. In at least one example, the total expected visit rate is based on the assumption that the exposed users were not exposed to the directed information. That is, the total expected visit rate represents a best estimate of the number of visits that would have occurred had there been no exposure to the directed information.

In aspects, the total number of actual visits (e.g., the total actual visit rate) that occurred by exposed users on eligible days may be identified. Identifying the actual visits may include querying one or more local and/or remote data sources. As a specific example, a visit detection and/or stop detection system may be queried for actual visit data corresponding to a user or set of users for one or more dates. The total actual visit rate may then be evaluated against the total expected visit rate to calculate the percentage increase in visit rate (e.g., visit lift) attributable to the directed information associated with the sets of collected data. In some aspects, the visit lift may be presented on a user interface, transmitted to one or more devices, or cause a report or notification to be generated.

Accordingly, the present disclosure provides a plurality of technical benefits including but not limited to: quantifying the total incremental lift in visit rate attributable to one or more actions or events; creating feature sets from visit and directed information impression data; quantifying the significance of various individual variables that influence the decision to visit; generating/training a visit prediction model having an open-ended number of control variables; using ML techniques to calculate the expected visit rate; leveraging existing visit data and stop detection data, among other examples.

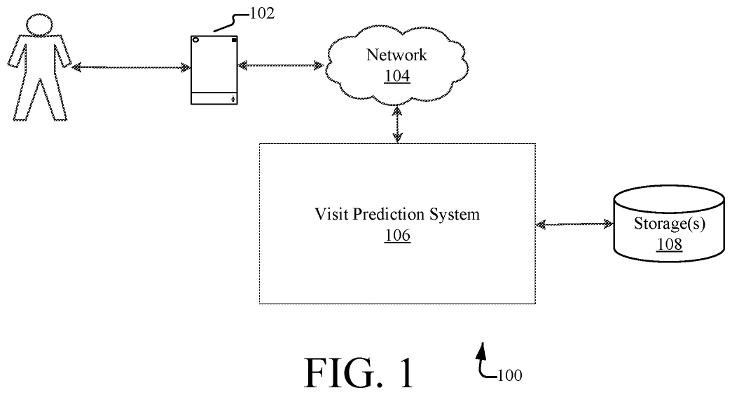

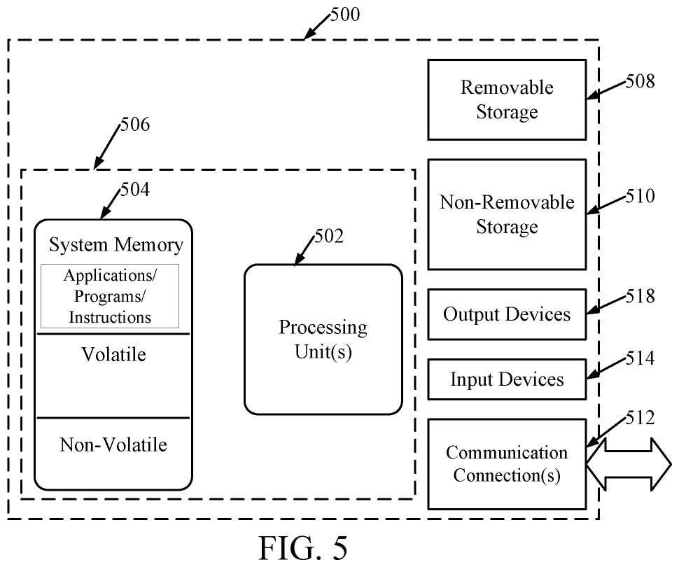

FIG. 1 illustrates an overview of an example system for visit prediction using ML techniques as described herein. Example system 100 presented is a combination of interdependent components that interact to form an integrated whole for venue detection systems. Components of the systems may be hardware components or software implemented on and/or executed by hardware components of the systems. In examples, system 100 may include any of hardware components (e.g., used to execute/run operating system (OS)), and software components (e.g., applications, application programming interfaces (APIs), modules, virtual machines, runtime libraries, etc.) running on hardware. In one example, an example system 100 may provide an environment for software components to run, obey constraints set for operating, and utilize resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic devices. As an example of a processing device operating environment, refer to the example operating environments depicted in FIG. 5. In other examples, the components of systems disclosed herein may be distributed across multiple devices. For instance, input may be entered on a client device and information may be processed or accessed from other devices in a network, such as one or more server devices.

As one example, the system 100 comprises computing device 102, distributed network 104, visit prediction system 106, and storage(s) 108. One of skill in the art will appreciate that the scale of systems such as system 100 may vary and may include more or fewer components than those described in FIG. 1. In some examples, interfacing between components of the system 100 may occur remotely, for example, where components of system 100 may be distributed across one or more devices of a distributed network.

Computing device 102 may be configured to receive and/or access information from, or related to, one or more users. The information may include, for example, user and/or device identification data (e.g., user name/identifier, device name, etc.), demographic data (e.g., age, gender, income, etc.), user visit data (e.g., venue name, geolocation coordinates, Wi-Fi information, length of stop/visit, date/time of visit, etc.), directed information data (e.g., directed information identifier, date of directed information impression, number of exposures, etc.), user feedback signals (e.g., active/passive venue check-in data, purchase or shopping events, or the like. Examples of computing device 102 may include client devices (e.g., a laptop or PC, a mobile device, a wearable device, etc.), server devices, web-based appliances, or the like.

In aspects, at least a portion of the data may be associated with directed information for one or more venues or locations. As a specific example, one or more sensors of computing device 102 may be operable to collect Wi-Fi information, accelerometer data, and check-in data when a user visits a venue for which the user was previously exposed to directed information for the venue. The information (or representations thereof) may be stored locally on computing device 102 or remotely in a remote data store, such as storage(s) 108. In some aspects, computing device 102 may transmit at least a portion of the data to a system, such as visit prediction system 106, via network 104.

Visit prediction system 106 may be configured to process and/or featurize the information. In aspects, visit prediction system 106 may have access to the information received/accessed by computing device 102. Upon accessing the information, visit prediction system 106 may process the information (or cause the information to be processed) to identify one or more features. The features may be divided into groups representing various users and/or various date/time periods. For example, for each user, a set of features may be created for each date identified in the information. For each set of features, a set of corresponding feature values may be calculated or identified and assigned to the set of features using one or more featurization techniques. Alternately, each group may be assigned a value for each feature in the set of features for that group. Visit prediction system 106 may additionally assign a visit indication value to one or more of the groups. The visit indication value may indicate whether a user visited a location or venue on a specific day. In at least one aspect, visit prediction system 106 may also assign to (or otherwise associate with) the one or more groups an exposure indication value indicating whether a user has been exposed to directed information within a statistically relevant time period. For example, the exposure indication value may categorize a user as unexposed, exposed and eligible for the visit analysis (e.g., user was exposed within the relevant time period of the visit analysis), or exposed and ineligible for the visit analysis (e.g., user was exposed, but the exposure was not within the relevant time period of the visit analysis).

Visit prediction system 106 may additionally be configured to train and/or maintain one or more predictive models. In aspects, visit prediction system 106 may have access to one or more predictive models/algorithms or a model generation component for generating one or more predictive models. As a specific example, visit prediction system 106 may comprise a ML model that uses one or more k-nearest-neighbor, gradient boosted tree, or logistic regression algorithms. Upon identifying/generating a relevant predictive model, visit prediction system 106 may use the identified features, feature values, visit indication value(s), and/or the exposure indication value(s) to train the predictive model to determine whether, or a probability that, a user visited a location/venue on a particular date. After the predictive model has been trained, visit prediction system 106 may provide additional information from one or more data sources to the trained model. In examples, the data sources may include computing device 102, other client devices associated with the user of computing device 102, client devices of other users, one or more cloud-based services/application, local and/or remote storage locations (such as storage(s) 108), etc. In at least one aspect, the additional information may include data for users exposed to the directed information discussed above. As part of the analysis/processing performed on the additional information by the predictive model, one or more attribution windows and/or eligible days for directed information associated with the additional information may be identified. For each eligible day identified, the predictive model may calculate and/or output a visit determination and/or a visit probability for each exposed user. The visit determinations/probabilities of the users may be summed to calculate the total expected visit rate of the users for a location or venue.

Visit prediction system 106 may additionally be configured to calculate the visit rate lift for directed information. In aspects, visit prediction system 106 may have access to data indicating the total number of actual visits (e.g., the total actual visit rate) that occurred by exposed users on the eligible days identified by the predictive model. Visit prediction system 106 may store the total actual visit rate data locally are may query one or more external data sources or services to access the total actual visit rate data. After accessing the total actual visit rate data, the predictive model or another component of (or accessible to) visit prediction system 106 may evaluate the total actual visit rate data against the total expected visit rate calculated previously. As a result of the evaluation, the visit rate lift (e.g., the percentage increase in visit rate attributable to the directed information associated with the data collected by computing device 102) may be calculated. In some aspects, after the visit rate lift has been calculated, visit prediction system 106 may cause one or more actions to be performed. As one example, visit prediction system 106 may produce a report measuring the effectiveness of directed information at driving consumers to physical locations. The report may also comprise data related to the causal impacts attributed to individual features/factors for various users or user groups.

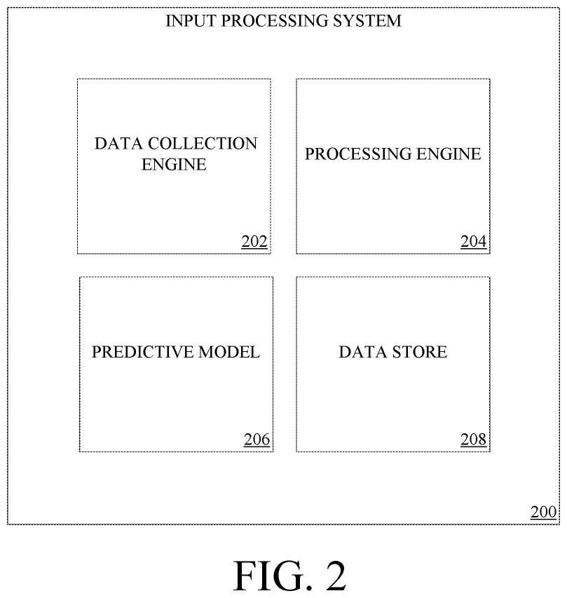

FIG. 2 illustrates an overview of an example input processing system 200 for visit prediction using ML techniques, as described herein. The visit prediction techniques implemented by input processing system 200 may comprise the visit detection techniques and data described in the system of FIG. 1. In some examples, one or more components (or the functionality thereof) of input processing system 200 may be distributed across multiple devices. In other examples, a single device may comprise (comprising at least a processor and/or memory) may comprise the components of input processing system 200.

With respect to FIG. 2, input processing system 200 may comprise data collection engine 202, processing engine 204, predictive model 206 and data store 208. Data collection engine 202 may be configured to collect or receive information relating to directed information. In aspects, data collection engine 202 may collect or receive visit information from one or more data sources or computing devices, such as computing device 102. The visit information may include, for example, user and/or device identification data, user demographic data, user visit and/or stop data, user behavior data, or the like. Data collection engine 202 may additionally collect or receive impression information relating to the directed information. The impression information may include, for example, directed information identification data, exposure data, or the like. Data collection engine 202 may store the collected data in one or more storage locations and/or make the collected data accessible to one or more applications, services or components accessible to input processing system 200. In at least one example, the collected data may be accessed via an interface (not pictured) provided by, or accessible to, input processing system 200. The interface may enable the collected data to be navigated and/or manipulated by a user. For instance, the interface may enable the collected data to be labeled, annotated and/or categorized.

Processing engine 204 may be configured to process the collected data. In aspects, processing engine 204 may have access to the data collected by data collection engine 202. Processing engine 204 may perform one or more operations on the collected data to process and/or format the collected data. For example, processing the collected data may include a merging operation. The merging operation may merge the visit information and the impression information according to user identification and/or date. For instance, a user's venue visit data may be matched to a user's directed information exposure using a user identifier and date pairing. Processing the collected data may additionally or alternately include a featurization operation. The featurization operation may identity various features on the collected data. The identified features may be grouped according to one or more criteria, such as user identifier and/or date. Values for each of the features in the groups may be determined using one or more ML techniques. Additionally, a visit indication value may be assigned to one or more of the groups. The visit indication value may indicate whether a user visited a location or venue on a specific day. For instance, a group may be assigned a ‘1’ if the user visited the location on a particular day, or a ‘0’ if the user did not visit the location on a particular day. In at least one aspect, the featurization operation may further include assigning an exposure indication value to one or more of the groups. The exposure indication value may indicate whether a user has been exposed to directed information within a statistically relevant time period of the visit analysis. For instance, a group may be assigned or otherwise associated with an ‘U’ to indicate the user was unexposed to the directed information, an ‘EE’ to indicate the user was exposed to the directed information within a statistically relevant time period of the visit analysis, or an ‘EI’ to indicate the user was exposed to the directed information outside of a statistically relevant time period of the visit analysis.

Predictive model 206 may be configured to output visit prediction values. In aspects, processing engine 204 may provide processed data to predictive model 206. The predictive model 206 may implement one or more ML algorithms, such as a k-nearest-neighbor algorithm, a gradient boosted tree algorithm, or a logistic regression algorithm. The processed data may be used to train predictive model 206 to determine a probability that a particular user (indicated in the processed data) visited a location/venue on a particular date. For example, based on processed data provided to predictive model 206, predictive model 206 may determine an attribution window for which the processed data is to be analyzed. In such an example, the processed data may primarily (or exclusively) comprise information for users exposed to the directed information described above. The attribution window may define the period of time in which the influence of the directed information exposure is statistically relevant for the visit decision. For each day identified in the attribution window, predictive model 206 may calculate a probability that a user identified in the processed data visited a target venue or location that day. The visit probabilities for each user and for each day may be summed to calculate a value representing the total expected visit rate of the users for a location or venue. In aspects, predictive model 206 may have access to actual visit data indicating the total number of actual visits (e.g., the total actual visit rate) that occurred by users exposed to the directed information during the attribution window. The actual visit data may be accessed locally in a data source, such as data store 208, or accessed remotely by querying one or more external data sources or services. After accessing the total actual visit rate data, predictive model 206 may evaluate the total actual visit rate data against the total expected visit rate to calculate the visit rate lift for the directed information. In some aspects, after calculating the visit rate lift for the directed information, predictive model 206 may cause on or more actions to be performed. For example, predictive model 206 may provide a report generation instruction to a reporting component of input processing system 200.

Having described various systems that may be employed by the aspects disclosed herein, this disclosure will now describe one or more methods that may be performed by various aspects of the disclosure. In aspects, methods 300 and 400 may be executed by a visit prediction system, such as system 100 of FIG. 1 or system 200 of FIG. 2. However, methods 300 and 400 are not limited to such examples. In other aspects, methods 300 and 400 may be performed on an application or service for performing visit prediction. In at least one aspect, methods 300 and 400 may be executed (e.g., computer-implemented operations) by one or more components of a distributed network, such as a web service/distributed network service (e.g. cloud service).

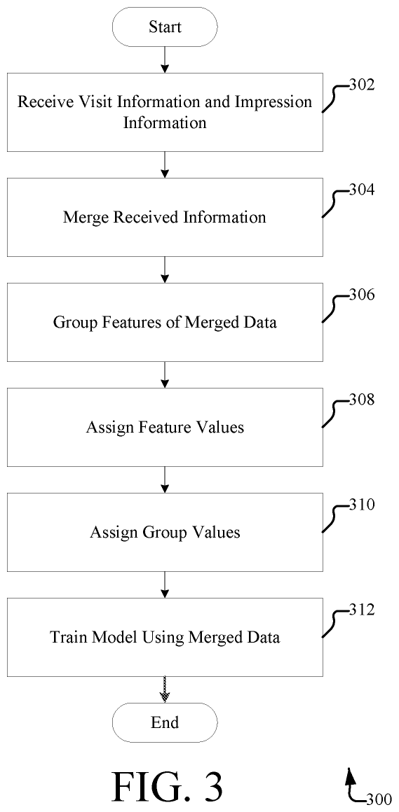

FIG. 3 illustrates an example method 300 for training a visit prediction model, as described herein. Example method 300 begins at operation 302, where information relating to directed information is received. In aspects, a data collection component, such as data collection engine 202, may receive visit information from one or more computing devices, such as computing device 102. The visit information may include, for example, user and/or device identification data, user demographic data, user visit and/or stop data, date/time data, user behavior data, or the like. In examples, the time period represented by the visit information may correspond to at least a portion of directed information. The data collection component may also receive impression information for the directed information from one or more data sources. The impression information may include, for example, directed information identification data, directed information exposure dates/times, user and/or device identification data, or the like.

At operation 304, the received information may be merged. In aspects, a data processing component, such as processing engine 204, may merge the visit information and the impression information into a single data set. Merging the information may include matching data in the visit information to data in the impression information using one or more pattern matching techniques, such as regular expressions, fuzzy logic, or the like. For example, a visit information data object and impression information data object may both comprise user identifier ‘X.’ A regular expression utility may be used to identify the commonality (i.e., user identifier ‘X’) in both data objects. Based on the identified commonality the two data objects may be merged into a new, third data object comprising at least a portion of the information from each of the two data objects.

At operation 306, features of the merged information may be grouped. In aspects, a data processing component, such as processing engine 204, may identify various features of the merged information. The identified features may be organized into groups corresponding to individual users and/or individual days. For example, each feature of the merged information that corresponds to user identifier ‘X’ and day ‘1’ may be organized into a first group, each feature of the merged information that corresponds to user identifier ‘X’ and day ‘2’ may be organized into a second group, etc. In some aspects, group names may be assigned to the groups. The group names may be based on the information used to organize the groups. As one example, for a group comprising information for user identifier ‘X’ and day ‘ 1,’ the group name ‘X:1’ may be automatically generated and assigned by the data processing component. Alternately, the group names may be assigned randomly and may not be immediately (or at all) indicative of the information comprise in the group. In at least one aspect, the group names may be assigned and/or modified manually using an interface accessible to the data processing component.

At operation 308, values for one or more features may be assigned. In aspects, feature values may be calculated and/or identified for the features in each group using one or more featurization techniques. For example, feature-value pairings and information data objects in the merged information may be identified and evaluated. The evaluation may include identifying and/or extracting the values for one or more features, normalizing the values, and assigning the normalized values to the respective features. As another example, values representing the casual impacts of impression features on user visitation behavior may be calculated. For instance, the merged data (or a group therein) may comprise the features gender, age, and income. Based on one or more attribution models/algorithms, it may be determined that gender is attributed a 70% influence on visitation behavior, age is attributed a 25% influence on visitation behavior, and income is attributed a 70% influence on visitation behavior. As a result, the feature value for gender may be set to 0.70, the feature value for age may be set to 0.25, and the feature value for income may be set to 0.05. Alternately, the respective feature values may be weighted according to the influence of the corresponding feature or the propensities of one or more users. For instance, features may be categorized into ranges having certain values. As a specific example, the age range 18-30 may be categorized as a first bucket having a value of 3, the age range 31-45 may be categorized as a second bucket having a value of 2, and the age range 46-60 may be categorized as a third bucket having a value of 1. The bucket values (e.g., 3, 2, 1) may represent the estimated influence of each age range on visit behavior. Weights may be applied to the values of each bucket to reflect the combined influence values for the feature and the associated ranges of the feature. Thus, if age is attributed a 25% influence on visitation behavior, the age bucket values for buckets 1, 2 and 3 may be calculated to have total influences of 0.75, 0.50 and 0.25, respectively.

At operation 310, values for one or more groups may be assigned. In aspects, the data processing component may assign each group a visit indication value indicating whether a user visited a location or venue on a specific day. For example, a group designated ‘X:1’ (corresponding to user identifier ‘X’ and day ‘1’) may be assigned a ‘1’ if the user visited the location on a particular day or ‘0’ if the user did not visit the location on a particular day. As a result, the group designation may be modified to, for example, ‘X:1:1’ or a ‘X:1:0’ accordingly. In some aspects, the data processing component may assign each group an exposure indication value indicating whether a user has been exposed to directed information within a statistically relevant time period of the visit prediction analysis. For example, each group may be assigned (or otherwise associated with) an ‘U’ to indicate the user was unexposed to the directed information, an ‘EE’ to indicate the user was exposed to the directed information within a statistically relevant time period of the visit analysis, or an ‘EI’ to indicate the user was exposed to the directed information outside of a statistically relevant time period of the visit analysis. In such an example, the statistically relevant time period may be predefined as a certain number of days subsequent to (or including) the date a user is exposed to directed information. In some aspects, the relevance impact of the days within the statistically relevant time period increasingly diminishes as days become further from the exposure date. For instance, the statistically relevant time period for directed information may be defined as 4 days (e.g., the exposure date and the three subsequent days). A determination may be made that the relevance of the exposed directed information diminished 25% every day after the exposure date. As a result, a 1.0 multiplier may be applied to the exposure date, a 0.75 multiplier may be applied to the first day after the exposure date, a 0.50 multiplier may be applied to the second day after the exposure date, and a 0.25 multiplier may be applied to the third day after the exposure date. In at least on aspect, the relevance multipliers may be applied to the feature values and/or group values.

At operation 312, a model may be trained using the merged data. In aspects, predictive model, such as predictive model 206, may be identified or generated. Alternately, multiple predictive models may be identified or generated. For example, a first predictive model may be trained primarily (or exclusively) using information for exposed users, and a second predictive model may be trained primarily (or exclusively) using information for unexposed users. The predictive model may be a binary, bias-corrected logistic regression model trained using the merged data and/or the group data (e.g., grouped features and values, group values and/or names, etc.) to determine whether, or a probability that, one or more users identified in the merged data visited a location/venue on a particular date. In examples, the use of bias-corrected logistic regression techniques enables the model to account for unfair sampling bias in the data used to train the model. That is, an appreciable number of rare positive outcome examples (e.g., venue/location visits) may be included in the training data set while ensuring that the model's analysis is based on the actual base rate of positive and negative visit outcomes. In a particular aspect, the particular bias-corrected logistic regression technique employed may be explained by introducing the notation so to represent the sampling rate applied to negative training instances (non-visits) and s₁ to represent the sampling rate for positive training instances (visits). In such aspects, the practical goal is for s₁ to be quite large (often exactly equal to 1, which means there is no downsampling in order to preserve the discriminative information from rare visit data, while s₀, is adjusted low (e.g., below 0.01). This may ensure that downsampling of negative training data is controlled to maintain an overall training data size set that meets any size constraints tied to computer memory limitations, processing times, or other operating constraints that apply to model fitting.

In aspects, the predictive model may be subject to certain confidence intervals, for example, as a lift calculation may not factor in statistical significance, a probability distribution over all possible lift seines may be generated. The probability distribution may incorporate a priori knowledge of lift distribution. In some aspects, a statistical model or algorithm, such as a Markov Chain Monte Carlo (MCMC) algorithm, may be used to sample data from the probability distribution. MCMC, as used herein, may refer to a random-walk based algorithm that moves data points in a manner dependent on a probability distribution. Using the sampled data, various values (e.g., average, median, percentiles, standard deviation, variance, etc.) may be calculated as expressions of the distribution order statistics of lift. For instance, the median value for the probability distribution may be identified and a confidence interval bounded by, for example, the 5^{th} percentile and the 95^{th} percentile may be established.

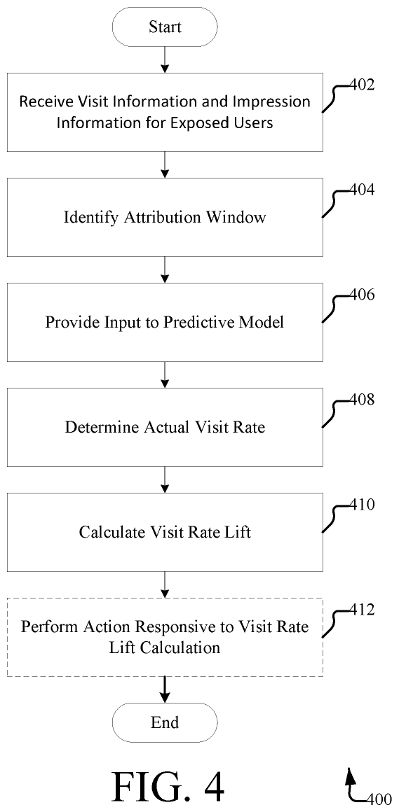

FIG. 4 illustrates an example method 400 for determining user visit lift, as described herein. Example method 400 begins at operation 402, where information for users exposed to directed information is identified. In aspects, a data collection component, such as data collection engine 202, may receive visit information for one or more users exposed to directed information (e.g., exposed users). In some aspects, the visit information may additionally include information for one or more users not exposed to the directed information (e.g., unexposed users). The visit information may be received from one or more computing devices, such as computing device 102, or one or more data sources, such as data store 208. In at least one specific example, the visit information may be collected from a contextual awareness engine that records user visitation patterns to venues and locations. The visit information may include, for example, user and/or device identification data, user demographic data, user visit and/or stop data, date/time data, user behavior data, or the like. In aspects, the data collection component may also receive, from one or more data sources, impression information associated with the users. The impression information may include, for example, directed information identification data, directed information exposure dates/times, user and/or device identification data, or the like.

In some aspects, the received visit information and/or impression information may correspond to a set of users having particular features or attributes. The features of the set of users may be the same as (or substantially similar to) the features of a set of training data used to train the predictive model described in method 300 of FIG. 3. For example, a predictive model may be trained using five features (e.g., age, gender, metropolitan area, visit recency, and language) of users in a set of training data. As a result, for each user in the training data, one or more users having features that match (or are similar to) the user in the training data may be identified, and visit information for the identified set of users may be received/collected. In at least one aspect, the received visit information and/or impression information may be merged. Merging the information may comprise identifying various features of the information and grouping the information into one or more groups. Merging the information may also comprise generating values for the features and/or groups, as described in method 300 of FIG. 3.

At operation 404, an attribution window may be identified. In aspects, the attribution window for the directed information exposed to the exposed users may be identified. The attribution window may comprise the directed information exposure data and a number of days subsequent to the exposure date. In examples, the attribution window may be preselected by a user associated with the administration or management of the directed information. In other examples, the attribution window may be predefined by the data collection component or a component of the visit prediction system. In yet other examples, the attribution window may be dynamically determined based on the received visit information and/or impression information. For instance, one or more ML techniques may be used to define a time period for which the influence of directed information remains statistically relevant after a user has been exposed to the directed information. The ML techniques may assign values to each day of the attribution window to represent the diminishing relevancy impact of the directed information for days further from the directed information exposure date.

At operation 406, the received information may be provided as input to a predictive model. In aspects, the received visit information, impression information and/or corresponding feature and group data may be provided as input to a predictive model, such as predictive model 206. The predictive model may be, for example, a binary logistic regression model trained to determine whether, or a probability that, users identified in the received information visited a location/venue on a particular date. For example, the information input to the predictive model may be organized into groups corresponding to user and/or date. The feature data of each group may be provided to the predictive model. As a result, the predictive model may output a probability that a particular user visited a target venue or location on a particular date. In aspects, the probabilities output by the predictive model may be summed to calculate a value indicating the total expected visit rate for a location or venue. The total expected visit rate may be based on the assumption that the users represented in the information input to the predictive model were not exposed to the directed information.

At operation 408, the actual visit rate for a location or venue may be determined. In aspects, the total number of actual visits that occurred by users during the attribution window may be identified. In examples, the total number of actual visits may correspond to the number of users exposed to the directed information, the number of users not exposed to the directed information, or some combination thereof. Identifying the total number of actual visits may comprise querying one or more services and/or remote data sources. Alternately, identifying the total number of actual visits may comprise receiving input manually entered by a user using an interface.

At operation 410, visit rate lift may be calculated. In aspects, the total number of actual visits (e.g., the total actual visit rate) may be evaluated against the total expected visit rate to calculate the visit rate lift of the directed information (e.g., the percentage increase in visit rate attributable to the directed information). In one specific example, the visit rate lift may be calculated using the following equation:

$$lift = \frac{{visits}_{actual}}{{visits}_{estimated}} = \frac{{Σ}_{d ∈ D} visited ? ( d )}{{Σ}_{d ∈ D} probVisited ? ( d )}$$

With respect to the above equation, d is a single eligible day (represents both a user and a date, where the user has been exposed to the directed information recently before that date); D is the set of all eligible D days in the analysis; visited? (d) is whether the user encoded in d visited the target chain on that date; probVisited? (d) is the probability that the unexposed user will visit on date d; visits_{actual} is the total number of visits that actually took place on eligible days; and visits_{estimated} is the total estimated number of visits that took place by unexposed users on eligible days.

At optional operation 412, one or more actions may be performed responsive to calculating the visit lift rate. In aspects, in response to calculating the visit lift rate, one or more actions or events may be performed. The actions/events may include generating a report, providing information to a predictive model, comparing the results of two or more predictive models, calculating one or more confidence intervals for the calculated visit lift rate, adjusting the statistical significance of various feature and/or feature values, etc. As one specific example, a report measuring the effectiveness of directed information may be generated and displayed to one or more users. The report may include the various features analyzed, the estimated causal impact of the features on visitation behavior, and/or the attribution window during which the visit prediction analysis was conducted.

FIG. 5 illustrates an exemplary suitable operating environment for the venue detection system described in FIG. 1. In its most basic configuration, operating environment 500 typically includes at least one processing unit 502 and memory 504. Depending on the exact configuration and type of computing device, memory 504 (storing, instructions to perform the visit prediction embodiments disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc. In embodiments, the connections may be operable to facility point-to-point communications, connection-oriented communications, connectionless communications, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
one or more processors; and
memory coupled to at least one of the one or more processors, the memory comprising computer executable instructions that, when executed by the at least one processor, performs a method comprising:
receiving visit information associated with one or more users;
receiving impression information relating to directed information, wherein the impression information is associated with at least a portion of the one or more users;
merging the visit information and the impression information to create merged data, wherein the merged data comprises a set of features;
grouping the set of features into a set of groups;
assigning one or more feature values for the set of features;
assigning one or more group values for the set of groups; and
training a machine learning model using the merged data.

2. The system of claim 1, wherein the visit information comprises at least two of: user identification data, demographic data, or user visit behavior data.

3. The system of claim 1, wherein the impression information comprises at least two of:
directed information identification data, directed information exposure data, or user identification data.

4. The system of claim 1, wherein creating the merged data comprises matching a portion of the visit information to a portion of the impression information.

5. The system of claim 1, wherein grouping the set of features comprises organizing the set of groups according to at least one of user or day.

6. The system of claim 5, wherein the set of groups is assigned names according to at least one of the user or the day.

7. The system of claim 1, wherein assigning one or more feature values comprises calculating values representing causal impacts of impression information features on user visitation behavior.

8. The system of claim 1, wherein assigning one or more group values comprises determining a visit indication value indicating whether a user visited a location on a specified day.

9. The system of claim 1, wherein assigning one or more group values comprises determining an exposure indication value indicating whether a user has been exposed to the directed information.

10. The system of claim 1, wherein the machine learning model is a binary logistic regression model used to determine a probability the one or more users identified in the merged data visited a location on a specified date.

11. A system comprising:
one or more processors; and
memory coupled to at least one of the one or more processors, the memory comprising computer executable instructions that, when executed by the at least one processor, performs a method comprising:
receiving visit information associated with one or more users, wherein the one or more users have been exposed to directed information;
receiving impression information relating to the directed information, wherein the impression information is associated with at least a portion of the one or more users;
idenitifying an attribution window associated with the directed information;
providing the visit information and the impression information within the attribution window to a machine learning model to calculate an expected visit rate for the one or more users;
determining an actual visit rate for the one or more users; and
evaluating the expected visit rate against the actual visit rate to calculate a visit lift rate.

12. The system of claim 11, wherein the visit information is collected from a contextual awareness engine that records user visitation patterns to locations.

13. The system of claim 11, wherein the attribution window defines a date of exposure to the directed information and a number of days subsequent to the date of exposure.

14. The system of claim 11, wherein the machine learning model is a binary logistic regression model.

15. The system of claim 11, wherein the expected visit rate represents a probability that the one or more users visited one or more locations on one or more days.

16. The system of claim 11, wherein the actual visit rate represents a number of visits that actually occurred by users during the attribution window.

17. The system of claim 11, wherein the visit lift rate represents a percentage increase in visit rate attributable to the directed information.

18. The system of claim 11, wherein calculating the visit lift rate comprises dividing the actual visit rate by the expected visit rate.

19. The system of claim 11, wherein the method further comprises:
performing one or more actions responsive to calculating the visit rate lift, wherein the one or more actions include automatically generating a report.

20. A method comprising:
receiving visit information associated with one or more users, wherein the one or more users have been exposed to directed information;
receiving impression information relating to the directed information, wherein the impression information is associated with at least a portion of the one or more users;
idenitifying an attribution window associated with the directed information;
providing the visit information and the impression information within the attribution window to a machine learning model to calculate an expected visit rate for the one or more users;
determining an actual visit rate for users during the attribution window; and
calculate a visit lift rate using the expected visit rate and the actual visit rate, wherein the visit lift rate represents an increase in visit rate attributable to exposure to the directed information.
